(19) United States
(12) Patent Application Publication
(10) Pub. No.: US 2016/0371345 A1
(43) Pub. Date: Dec. 22, 2016

(54) Preprocessing Heterogeneously-Structured Electronic Documents for Data Warehousing

(71) Applicant: International Business Machines Corporation, Armonk, NY (US)

(72) Inventors: Igor Kostirev, Kibutz Adamit (IL); Alex Melament, Kiriat Mozkin (IL); Yardena L. Peres, Haifa (IL); Edward Vitkin, Nesher (IL)

(21) Appl. No.: 14/745,469

(22) Filed: Jun. 22, 2015

(51) Int. Cl. G06F 17/30

(52) U.S. Cl. CPC G06F 17/30563; G06F 17/30011; G06F 17/30327; G06F 17/30867; G06F 17/30598; G06F 17/30592; G06F 17/30699

(57) ABSTRACT

Preprocessing heterogeneously-structured electronic documents for data warehousing, by semantically filtering a set of electronic documents, where each of the electronic documents is representable as a structural tree of nodes representing items of data, determining a distance between a plurality of pairs of the structural trees, identifying a plurality of clusters of the electronic documents based on the distances between the structural trees of the electronic documents, and removing any of the clusters based on predefined cluster filtering criteria.

### BACKGROUND

One of the major difficulties faced by researchers, such as in the areas of wellness research (WR) or medical research (MR), is gathering cohorts of subject data for study. To address this, researchers often collect data from multiple sources, such as from various WR research facilities or local hospitals for MR research. Although this may simplify cohort data gathering, it presents additional data processing challenges, particularly with regard to Extract, Transform and Load (ETL) processing of data warehousing system, as different data sources may provide their data in different data formats.

### SUMMARY

In one aspect of the invention a method is provided for preprocessing heterogeneously-structured electronic documents for data warehousing, the method including semantically filtering a set of electronic documents, where each of the electronic documents is representable as a structural tree of nodes representing items of data, determining a distance between a plurality of pairs of the structural trees, identifying a plurality of clusters of the electronic documents based on the distances between the structural trees of the electronic documents, and removing any of the clusters based on predefined cluster filtering criteria.

In other aspects of the invention, systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for preprocessing heterogeneously-structured electronic documents for data warehousing, constructed and operative in accordance with an embodiment of the invention;

FIGS. 2A and 2B, taken together, illustrates the representation of electronic document data as a tree of nodes in accordance with an embodiment of the invention;

FIG. 3 is a simplified flowchart illustration of an exemplary method of operation of the system of FIG. 1, operative in accordance with an embodiment of the invention; and

FIG. 4 is a simplified block diagram illustration of an exemplary hardware implementation of a computing system, constructed and operative in accordance with an embodiment of the invention.

### DETAILED DESCRIPTION

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

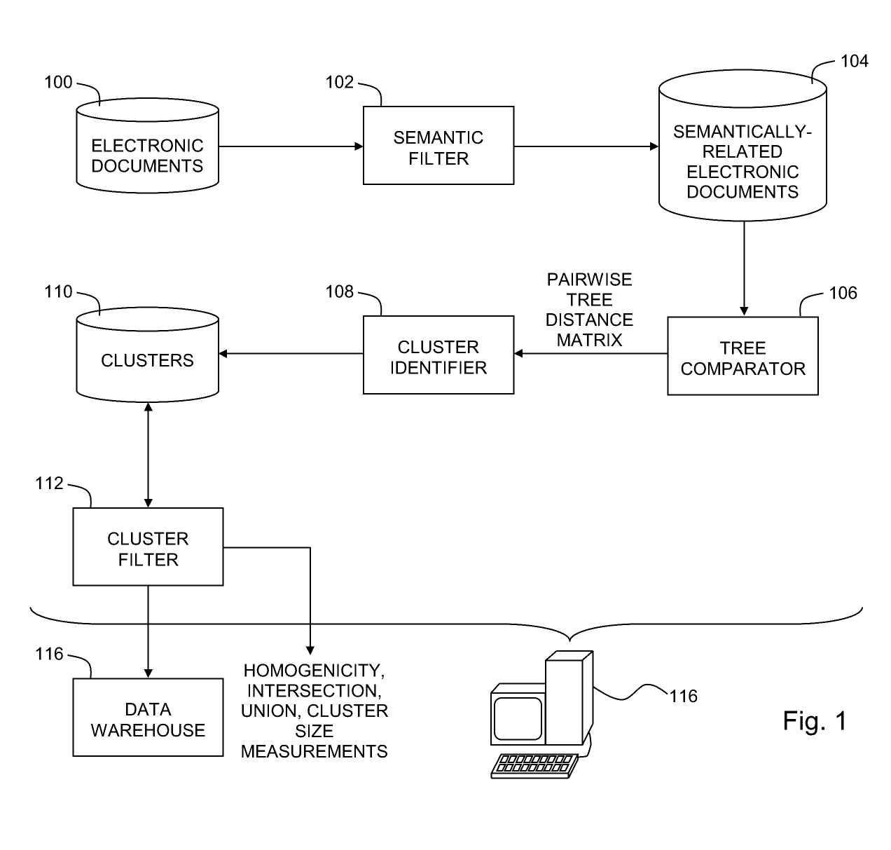

Reference is now made to FIG. 1, which is a simplified conceptual illustration of a system for preprocessing heterogeneously-structured electronic documents for data warehousing, constructed and operative in accordance with an embodiment of the invention. In the system of FIG. 1, a set of electronic documents 100 is filtered by a semantic filter 102 to create a set of semantically-related electronic documents 104. Set of electronic documents 100 may include electronic documents in structured data formats, such as spreadsheets or relational databases. or semi-structured formats, such as in XML and JSON formats, as well as electronic documents that comply with industrial standards, such as HL7 or CDA, and electronic documents that belong to proprietary formats. Semantic filter 102 is configured in accordance with any known semantic filtering technique, such as where semantic filter 102 is configured to perform a free text search of set of electronic documents 100 to determine the presence of one or more required strings, and move into, or copy into, set of semantically-related electronically documents 104 only those electronic documents in set of electronic documents 100 that include the required strings. Alternatively, semantic filter 102 creates set of semantically-related electronically documents 104 by removing from set of electronic documents 100 any electronic documents that do not include the required strings.

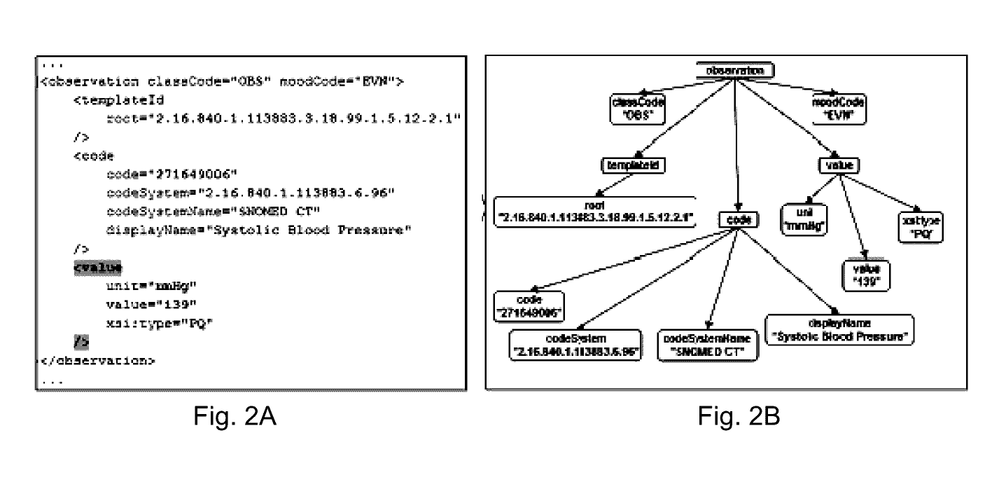

A tree comparator 106 relates to data of each document in set of semantically-related electronically documents 104 as a tree of nodes, where each node includes a mandatory label describing an item of data and an optional value of the item of data. For example, an XML document such as is shown in FIG. 2A may be represented as a tree of nodes as is shown in FIG. 2B. Tabular electronic documents, such as in CSV format, may be represented as a tree of nodes using an artificial root node and addressing each column title as a mandatory node label, resulting in a one-node depth tree. Each tree of nodes without their optional node values is referred to herein as a “structural tree.” Given the structural tree for each electronic document in set of semantically-related electronically documents 104, tree comparator 106 determines a distance between each pair (A,B) of the structural trees, such as by using a Tree Edit Distance (TED) function to calculate the minimal cost of all possible sequences of edit operations which convert A to B. The cost of a sequence of edit operations is defined as sum of costs of its component operations as

$$TED ( A , B ) = {min}_{A -> B} \{ Cost ( A -> B ) \}$$

The TED function is preferably calculated either for the removeLeaf/SubTree edit operation or for the insertLeaf/SubTree edit operation. For example, TED(A,B) may be calculated using the following algorithm:

0. Input:
a. TreeA+rootA (root of treeA)
b. TreeB+rootB (root of treeB)
c. CostRemoveSubTree(treeT, nodeN)−cost function to remove sub-tree of nodeN from the tree treeT.

Output:
TED(TreeA, TreeB)

1. Initialize:
a. Na=number of children of rootA+1
b. Nb=number of children of rootB+1
c. DistMatrix=double[Na×Nb]

2. DistMatrix(0,0)=
a. 0: rootA==rootB
   or
b. CostRemoveSubTree(treeA, rootA)+CostRemoveSubTree(treeB, rootB): o/w

3. DistMatrix(i>0,0)=DistMatrix(i-1,0)+TED(treeA, son_i of rootA, treeB, rootB)

4. DistMatrix(0, j>0)=DistMatrix(i,j-1)+TED(treeA, rootA, treeB, son_j of rootB)

5. DistMatrix(i>0, j>0)=min of:
a. DistMatrix(i-1,j)+CostRemoveSubTree(treeA, son_i of rootA)
b. DistMatrix(i,j-1)+CostRemoveSubTree(treeB, son_j of rootB)
c. DistMatrix(i,j)+TED(treeA, son_i of rootA, treeB, son_j of rootB)

6. Return DistMatrix(Na,Nb)

A cluster identifier 108 identifies clusters 110 of electronic documents in set of semantically-related electronically documents 104 based on the distances between their structural trees. Cluster identifier 108 is configured in accordance with any known clustering algorithm, such as where cluster identifier 108 is configured to construct a hierarchical cluster of electronic documents using a variation of the Neighbor-Joining (NJ) method, where the hierarchical cluster is represented as a binary tree in which, for every three leaf nodes representing electronic documents A, B and C, if a common ancestor of A and B is lower than a common ancestor of A and C, then A is expected to be closer to B than to C. Thus, each internal (i.e., non-leaf) node of the hierarchical cluster represents a cluster of all the leaf nodes that descend from it, where each leaf node represents a single electronic document, and the root nodes represents all of the electronic documents in set of semantically-related electronically documents 104.

For example, a hierarchical cluster tree may be constructed using the following algorithm:

0. Input:
a. Set of N structural trees of N electronic documents
b. Matrix of pairwise distances between the structural trees
c. Cluster merging function, which is a function evaluating intersections of structural trees.

Output:
HIERARCHY tree—a hierarchical cluster tree where each leaf of the tree represents an electronic document and each internal node represents a cluster of all the leaf nodes that descend from it.

1. Initialize
a. Create N singleton clusters representing the N electronic documents.
b. Create N centroids to represent each singleton cluster, where each centroid is the structural tree of its associated electronic document. An initial distance matrix is constructed to represent the distances between cluster centroids.
c. Create N leaves in HIERARCHY tree.

2. While N>1 do
a. Pick the closest pair of clusters cA and cB (according to the distance matrix).
b. Create a new cluster cAB representing the union (merger) of cA and cB.

This cluster represents the internal node which is the lowest common ancestor between cA and cB sub-trees. Create a node for cAB in HIERARCHY tree.
c. Create a centroid for the newly created cluster as an intersection tree (as defined below) of the structural trees of cA and cB.
d. Estimate the distances between the newly created cluster cAB and all the other clusters (based on the TED between the created centroid and the centroids of other clusters).
d. Update the distance matrix by removing rows for cA and cB and adding a row for cAB.
e. N=N−1 (number of cluster decreased)

3. Return resulting HIERARCHY tree.

A cluster filter 112 removes clusters from clusters 110 based on predefined cluster filtering criteria. For example, for each cluster of electronic documents in clusters 110, a measure of homogeneity may be determined based on the Jaccard similarity coefficient using the formula:

$$Homogeneity ( Cluster ) = 100 ⋆ \frac{⋂ {Tree}_{i}}{⋃ {Tree}_{i}} = 100 ⋆ \frac{\vert {Intersect}_{Cluster} \vert}{\vert {Union}_{Cluster} \vert}$$

where Intersect is a maximal (i.e., cannot add another node) tree whose every path, from its root to each of its leaf nodes, exists in every structure tree of every electronic document in the cluster, expressed as ∀path∈Intersect: ∀Treeᵢ∈Cluster: path∈Tree ᵢ

where Union is a minimal (i.e., cannot remove any node) tree whose every path, from its root to each of its leaf nodes, exists in at least in one structure tree of the electronic documents in the cluster, expressed as ∀path∈Union: ∃Treeᵢ∈Cluster: path∈Treeᵢ, and

where homogeneity of a cluster, which is preferably measured in percent, is a measure of intra-cluster document variability, providing information about the difference between the intersection and the union.

Where clusters 110 are represented as a hierarchical cluster tree as described hereinabove, cluster filter 112 “prunes” the hierarchical cluster tree based on node homogeneity, preferably starting from the root of the hierarchical cluster tree, removing nodes from the hierarchical cluster tree whose homogeneity is below a predefined threshold, such as may be set by a user of the system of FIG. 1, thereby creating multiple sub-trees from branches of the hierarchical cluster tree, each having its own root node. Cluster filter 112 preferably continues pruning the various sub-trees until the homogeneity of each sub-tree root node is at or above the predefined threshold.

Cluster filter 112 also preferably removes from clusters 110 any clusters having fewer electronic documents than a predefined minimum number of electronic documents, such as may be set by a user of the system of FIG. 1. Cluster filter 112 also preferably provides measurements of cluster homogeneity, union, intersection, and size to a user of the system of FIG. 1, which information may be used to decide which of clusters 110 to include in an Extract, Transform and Load (ETL) process, such as of a data warehouse 114.

Any of the elements shown in FIG. 1 are preferably implemented by one or more computers, such as a computer 116, in computer hardware in computer hardware and/or in computer software embodied in a non-transitory, computer-readable medium in accordance with conventional techniques.

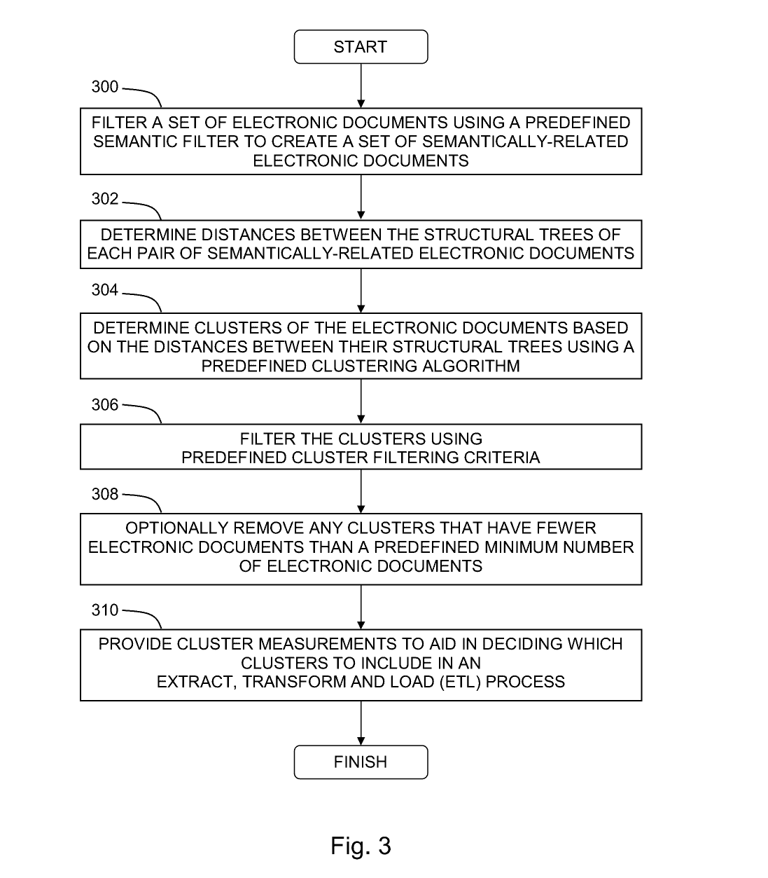

Reference is now made to FIG. 3 which is a simplified flowchart illustration of an exemplary method of operation of the system of FIG. 1, operative in accordance with an embodiment of the invention. In the method of FIG. 3, a set of electronic documents is filtered using a predefined semantic filter to create a set of semantically-related electronic documents (step 300). Given a structural tree for each of the electronic documents, where each structural tree represents the data of its corresponding electronic document, distances are determined between each pair of structural trees using a predefined distance function (step 302). Clusters of the electronic documents are determined based on the distances between their structural trees using a predefined clustering algorithm (step 304). The clusters are filtered using predefined cluster filtering criteria (step 306), such as by traversing a hierarchical cluster tree starting from the root node and removing any nodes whose homogeneity is below a predefined threshold. Optionally, any clusters may also be removed if they have fewer electronic documents than a predefined minimum number of electronic documents (step 308). Various cluster measurements, such as of cluster homogeneity, union, intersection, and size, are preferably provided to aid in deciding which clusters to include in an Extract, Transform and Load (ETL) process (step 310).

In an alternative embodiment of the invention, semantic filtering (step 300) may be performed after the clusters have been determined (step 304).

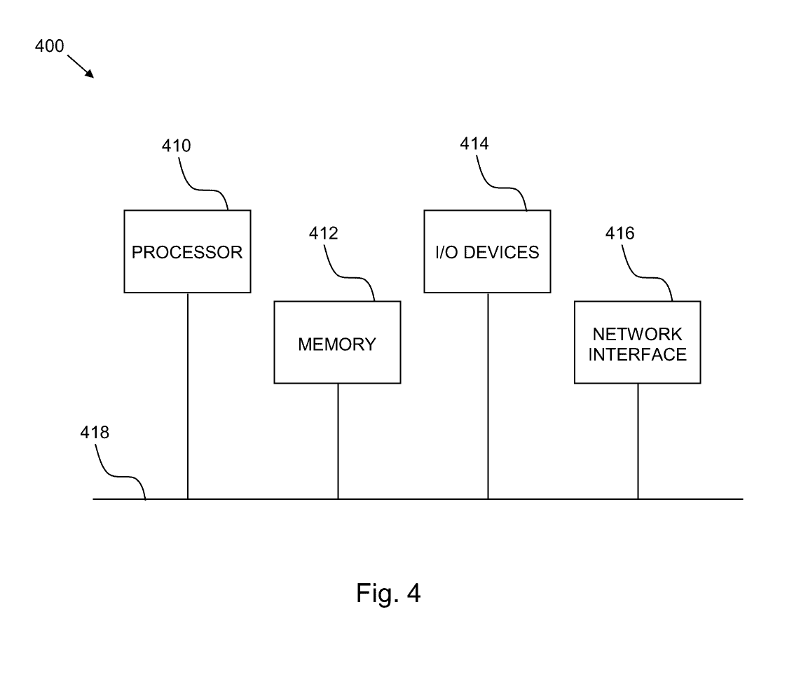

Referring now to FIG. 4, block diagram 400 illustrates an exemplary hardware implementation of a computing system in accordance with which one or more components/methodologies of the invention (e.g., components/methodologies described in the context of FIGS. 1-3) may be implemented, according to an embodiment of the invention.

As shown, the techniques for controlling access to at least one resource may be implemented in accordance with a processor 410, a memory 412, I/O devices 414, and a network interface 416, coupled via a computer bus 418 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for preprocessing heterogeneously-structured electronic documents for data warehousing, the method comprising:
semantically filtering a set of electronic documents, wherein each of the electronic documents is representable as a structural tree of nodes representing items of data;
determining a distance between a plurality of pairs of the structural trees;
identifying a plurality of clusters of the electronic documents based on the distances between the structural trees of the electronic documents; and
removing any of the clusters based on predefined cluster filtering criteria.

2. The method according to claim 1 wherein the determining comprises determining the distance between two of the structural trees using a Tree Edit Distance (TED) function to calculate a minimal cost of all possible sequences of edit operations which convert one of the two structural trees to the other of the two structural trees.

3. The method according to claim 2 and further comprising calculating the minimal cost wherein the TED function is calculated for a removeLeaf/SubTree edit operation or for an insertLeaf/SubTree edit operation.

4. The method according to claim 1 and further comprising representing the clusters as a hierarchy using a binary tree,
wherein the electronic documents are represented as leaf nodes of the binary tree,
wherein each of the clusters is represented as an internal node of the binary tree from which descend all the leaf nodes representing the electronic documents of the cluster, and
wherein for every three of the leaf nodes, if a first common ancestor internal node of a first one of the three leaf nodes and a second one of the three leaf nodes is hierarchically lower in the binary tree than a second common ancestor internal node of the first one of the three leaf nodes and a third one of the three leaf nodes, then the first one of the three leaf nodes is expected to be closer to the second one of the three leaf nodes than to the third one of the three leaf nodes.

5. The method according to claim 4 wherein the removing comprises removing wherein the cluster filtering criteria is based on a measure of homogeneity of each of the clusters, wherein homogeneity is a measure of intra-cluster document variability, and wherein the removing comprises removing any of the clusters whose measure of homogeneity is below a predefined threshold.

6. The method according to claim 5 and further comprising calculating the measure of homogeneity based on the Jaccard similarity coefficient using the formula:
$$Homogeneity ( Cluster ) = 100 ⋆ \frac{⋂ {Tree}_{i}}{⋃ {Tree}_{i}} = 100 ⋆ \frac{\vert {Intersect}_{Cluster} \vert}{\vert {Union}_{Cluster} \vert}$$
wherein Intersect is a maximal tree whose every path, from its root to each of its leaf nodes, exists in every structure tree of every electronic document in the cluster, expressed as ∀path∈Intersect: ∀Treeᵢ∈Cluster: path∈Treeᵢ, and
wherein Union is a minimal tree whose every path, from its root to each of its leaf nodes, exists in at least in one structure tree of the electronic documents in the cluster, expressed as ∀path∈Union: ∃Treeᵢ∈Cluster: path∈Tree_{i.}

7. The method according to claim 5 wherein the removing comprises removing any of the clusters starting from the root of the binary tree, thereby creating multiple sub-trees from branches of the binary tree, each having its own root node, and wherein the removing comprises removing any of the clusters starting from the root of any of the sub-trees until the measure of homogeneity of each sub-tree root node is at or above the predefined threshold.

8. The method according to claim 1 wherein the removing comprises removing any of the clusters having fewer electronic documents than a predefined minimum number of electronic documents.

9. The method according to claim 6 and further comprising providing measurements of cluster homogeneity, union, intersection, and size in support of an Extract, Transform and Load (ETL) process of a data warehouse.

10. The method of claim 1 wherein the semantically filtering, determining, identifying and removing are implemented in any of
a) computer hardware, and
b) computer software embodied in a non-transitory, computer-readable medium.

11. A system for preprocessing heterogeneously-structured electronic documents for data warehousing, the system comprising:
a semantic filter configured to semantically filter a set of electronic documents, wherein each of the electronic documents is representable as a structural tree of nodes representing items of data;
a tree comparator configured to determine a distance between a plurality of pairs of the structural trees;
a cluster identifier configured to identify a plurality of clusters of the electronic documents based on the distances between the structural trees of the electronic documents; and
a cluster filter configured to remove any of the clusters based on predefined cluster filtering criteria.

12. The system according to claim 11 wherein the tree comparator is configured to determine the distance between two of the structural trees using a Tree Edit Distance (TED) function to calculate a minimal cost of all possible sequences of edit operations which convert one of the two structural trees to the other of the two structural trees.

13. The system according to claim 12 wherein the TED function is calculated for a removeLeaf/SubTree edit operation or for an insertLeaf/SubTree edit operation.

14. The system according to claim 11 wherein the cluster identifier is configured to represent the clusters as a hierarchy using a binary tree,
wherein the electronic documents are represented as leaf nodes of the binary tree,
wherein each of the clusters is represented as an internal node of the binary tree from which descend all the leaf nodes representing the electronic documents of the cluster, and
wherein for every three of the leaf nodes, if a first common ancestor internal node of a first one of the three leaf nodes and a second one of the three leaf nodes is hierarchically lower in the binary tree than a second common ancestor internal node of the first one of the three leaf nodes and a third one of the three leaf nodes, then the first one of the three leaf nodes is expected to be closer to the second one of the three leaf nodes than to the third one of the three leaf nodes.

15. The system according to claim 14 wherein the cluster filtering criteria is based on a measure of homogeneity of each of the clusters, wherein homogeneity is a measure of intra-cluster document variability, and wherein the cluster filter is configured to remove any of the clusters whose measure of homogeneity is below a predefined threshold.

16. The system according to claim 15 wherein the measure of homogeneity is determined based on the Jaccard similarity coefficient using the formula:
$$Homogeneity ( Cluster ) = 100 ⋆ \frac{⋂ {Tree}_{i}}{⋃ {Tree}_{i}} = 100 ⋆ \frac{\vert {Intersect}_{Cluster} \vert}{\vert {Union}_{Cluster} \vert}$$
wherein Intersect is a maximal tree whose every path, from its root to each of its leaf nodes, exists in every structure tree of every electronic document in the cluster, expressed as ∀path∈Intersect: ∀Treeᵢ∈Cluster: path∈Treeᵢ, and
wherein Union is a minimal tree whose every path, from its root to each of its leaf nodes, exists in at least in one structure tree of the electronic documents in the cluster, expressed as ∀path∈Intersect: ∃Treeᵢ∈Cluster: path∈Tree_{i.}

17. The system according to claim 15 wherein the cluster filter is configured to remove any of the clusters starting from the root of the binary tree, thereby creating multiple sub-trees from branches of the binary tree, each having its own root node, and wherein the cluster filter is configured to remove any of the clusters starting from the root of any of the sub-trees until the measure of homogeneity of each sub-tree root node is at or above the predefined threshold.

18. The system according to claim 16 wherein the cluster filter is configured to provides measurements of cluster homogeneity, union, intersection, and size in support of an Extract, Transform and Load (ETL) process of a data warehouse.

19. The system of claim 11 wherein the semantic filter, the tree comparator, the cluster identifier, and the cluster filter are implemented in any of
a) computer hardware, and
b) computer software embodied in a non-transitory, computer-readable medium.

20. A computer program product for preprocessing heterogeneously-structured electronic documents for data warehousing, the computer program product comprising:
a non-transitory, computer-readable storage medium; and
computer-readable program code embodied in the storage medium, wherein the computer-readable program code is configured to
semantically filter a set of electronic documents, wherein each of the electronic documents is representable as a structural tree of nodes representing items of data,
determine a distance between a plurality of pairs of the structural trees,
identify a plurality of clusters of the electronic documents based on the distances between the structural trees of the electronic documents, and
remove any of the clusters based on predefined cluster filtering criteria.
